(19) United States
(12) Patent Application Publication
(10) Pub. No.: US 2023/0300409 A1
(43) Pub. Date: Sep. 21, 2023

(54) SYSTEM, METHOD, AND COMPUTER PROGRAM FOR ONLINE DATA TRANSFER

(71) Applicant: Amdocs Development Limited, Limassol (CY)

(72) Inventor: Pradeep Kumar Khowash, Dallas, TX (US)

(21) Appl. No.: 17/700,249

(22) Filed: Mar. 21, 2022

(51) Int. Cl. H04N 21/4402; H04N 21/4363; G06F 16/955

(52) U.S. Cl. CPC H04N 21/4402; G06F 16/955; H04N 21/43637

(57) ABSTRACT

As described herein, a system, method, and computer program are provided for online data transfer. Content to be transferred to a destination device over a network is identified, where the content is constructed from a plurality of components. The plurality of components of the content are determined. A plurality of links corresponding to the plurality of components are retrieved, where each link of the plurality of links corresponds to a different component of the plurality of components. The plurality of links are transferred to the destination device over the network.

### FIELD OF THE INVENTION

The present invention relates to processes for the transfer of data over a network.

### BACKGROUND

Broadband expansion has changed our media habits over time due to the availability of wireless internet and smartphones. A major part of the consumption takes place online through streaming platforms like Spotify™, Netflix™, Amazon™, and Disney+™. We’ve seen rising consumption of online newspapers, magazines, books, etc., and the demand for these services and in-home entertainment continues to increase.

Video quality has gained a lot of attention recently. Video compression techniques are used to reduce the size of previously uncompressed video drastically. This allows the compressed video to be saved more easily and to be sent over the network quickly. However, there is still a need for improved online data transfer techniques that minimize data transfer traffic across the network and reduce storage space and management complexities.

For example, WhatsApp™ is currently the most popular messaging app, with nearly 2 billion users of which about 1.6 billion are active. About half a billion people use WhatsApp daily, exchanging approximately 65 billion messages. Though most of these messages are text, about 4.5 billion photos and 1 billion videos are sent each day as well. This requires a robust communication network. In order to manage the throughputs, the maximum file size has been restricted to 16 Mb.

There is thus a need for addressing these and/or other issues associated with the prior art.

### SUMMARY

As described herein, a system, method, and computer program are provided for online data transfer. Content to be transferred to a destination device over a network is identified, where the content is constructed from a plurality of components. The plurality of components of the content are determined. A plurality of links corresponding to the plurality of components are retrieved, where each link of the plurality of links corresponds to a different component of the plurality of components. The plurality of links are transferred to the destination device over the network.

### BRIEF DESCRIPTION OF THE DRAWINGS

FIG. 1 illustrates a method for online data transfer, in accordance with one embodiment.

FIG. 2 illustrates a flow diagram of a system for online data transfer, in accordance with one embodiment.

FIG. 3 illustrates a method for reconstructing data, in accordance with one embodiment.

FIG. 4 illustrates a network architecture, in accordance with one possible embodiment.

FIG. 5 illustrates an exemplary system, in accordance with one embodiment.

### DETAILED DESCRIPTION

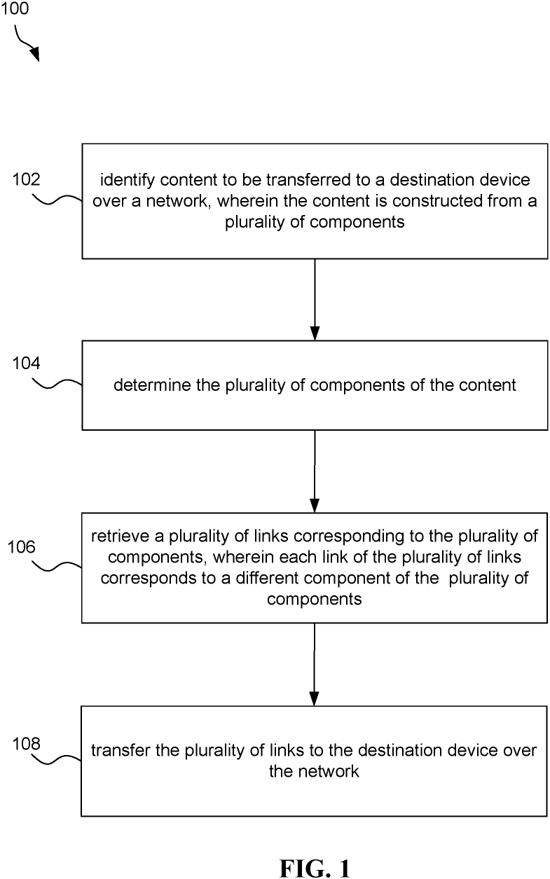

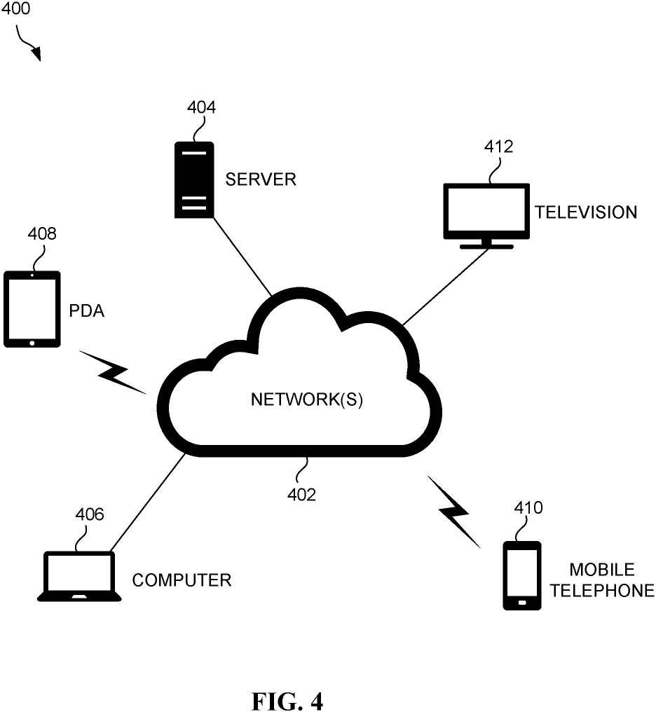

FIG. 1 illustrates a method 100 for online data transfer, in accordance with one embodiment. The method 100 may be performed by any computer system(s) described below with respect to FIGS. 4 and/or 5. For example, the method 100 may be performed by a computer system of a content provider.

In operation 102, content to be transferred to a destination device over a network is identified, where the content is constructed from a plurality of components. The network may by any public or private network. For example, the network may be a local area network. As another example, the network may be the Internet.

The destination device may be any computing device that is connected to the network and to which the content is capable of being transferred. In various embodiments, the destination device may be any of the computer system(s) described below with respect to FIGS. 4 and/or 5. Just by way of example, the destination device may be a user device (e.g. mobile phone, laptop, smart television, etc.).

Still yet, the content may be any digital content capable of being transferred (e.g. communications, sent, etc.) over the network to the destination device. For example, the content may be digital media content. However in any case, the digital content is constructed from a plurality of components, as noted above.

With respect to the present description, the plurality of components may be any sub-components of the content that is capable of being combined in some manner to construct the content. For example, the plurality of components may include two or more of: an image, a video, audio, or text. Thus, the content may be constructed from separate components that each correspond to a different component type (i.e. image, video, audio, text, etc.). In one exemplary embodiment, the content may include the text superimposed on the image or the video. In another exemplary embodiment, the content may include the video and the audio (e.g. which form a movie or television show).

In an embodiment, the content may be identified in response to receipt of a request to transfer the content to the destination device. The request may be received from the destination device, as an option. As another option, the request may be received from a provider of the content (i.e. the source of the content). Of course, however, the request may also be received by a third party to the destination and the source.

It should be noted that the transfer of the content over the network may be intended with respect to any possible communication channel. For example, the transfer may be intended to be made with respect to a messaging platform, a streaming platform, etc.

In operation 104, the plurality of components of the content are determined. In an embodiment, the plurality of components may be determined by analyzing the content or metadata associated with the content. In another embodiment, the content, or metadata for the content, may indicate (i.e. include identifiers of) the plurality of components from which the content is constructed. Thus, the plurality of components of the content may be determined from the content itself or from its corresponding metadata.

In operation 106, a plurality of links corresponding to the plurality of components are retrieved, where each link of the plurality of links corresponds to a different component of the plurality of components. A link refers to any identifier that indicates a storage location of a corresponding component. For example, a link may be a pointer or a uniform resource locator (URL).

In an embodiment, the plurality of components may be stored by at least one source device. As an option, only a single copy of each component of the plurality of components may be stored by the at least one source device. With respect to this option, each component of the plurality of components may be reusable to construct other content. By storing only a single copy of each component in this manner, as opposed to storing each different content as a whole (e.g. where multiple contents may include a same component), usage of storage resources may be reduced.

In another embodiment, the plurality of components may each be stored in a separate file of a plurality of files by the at least one source device. With respect to this embodiment, each link of the plurality of links may point to (e.g. identify) a different file of the plurality of files. In any case, the links corresponding to the various components of the content are retrieved. In one embodiment, the links may be retrieved from a source that stores already generated links for the components. In another embodiment, the links may be retrieved by a generator that generates the links for the components.

In operation 108, the plurality of links are transferred to the destination device over the network. The links may be transferred (e.g. communicated) the destination device using any communication channel, such as those mentioned above. For example, the links may be transferred in a message sent to the destination device.

By transferring the links to the destination device as opposed to the content itself, data transfer traffic across the network may be reduced. This may especially be true for the communication channel being used to communicate the links. As an option, a different communication channel may then be used by the destination device to actually retrieve the components.

In an embodiment, the destination device may retrieve the plurality of components using the plurality of links. For example, the destination device may request the components from the at least one source device by using the plurality of links. The destination device may then reconstruct the content using the retrieved plurality of components. In an embodiment, at least a portion of the plurality of components retrieved by the destination device may be compressed. In another embodiment, at least one component (e.g. video) of the plurality of components may be retrieved by the destination device in fixed length segments which may or may not be compressed.

More illustrative information will now be set forth regarding various optional architectures and uses in which the foregoing method may or may not be implemented, per the desires of the user. It should be strongly noted that the following information is set forth for illustrative purposes and should not be construed as limiting in any manner. Any of the following features may be optionally incorporated with or without the exclusion of other features described.

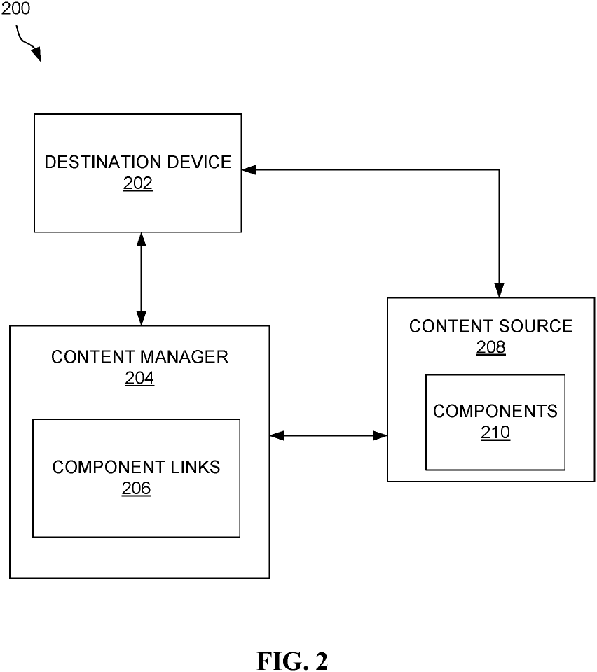

FIG. 2 illustrates a flow diagram of a system 200 for online data transfer, in accordance with one embodiment. As an option, the system 200 may be implemented in the context of the details of the previous figure and/or any subsequent figure(s). Of course, however, the system 200 may be implemented in the context of any desired environment. Further, the aforementioned definitions may equally apply to the description below.

With respect to the present embodiment, a destination device 202 is in communication with a content manager 204 and a content source 208, for example via one or more networks (now shown). The content source 208 stores components 210 that are capable of being used to construct content, and therefore may include any type of storage device. The content manager 204 stores (or otherwise has access to) links 206 to each of the components 210 stored by the content source 208.

The content manager 204 is notified that content is to be transferred to the destination device 202 over a network. For example, the destination device 202 may send a request for the content to the content manager 204. In response to the notification, content manager 204 determines which components 210 are required to construct the content. The content manager 204 then retrieves the links 206 to the determined components 210 and transfers the links to the destination device 202.

The destination device 202, upon receipt of the links 206, retrieves the components 210 from the content source 208 using the links 206. The destination device 202 then reconstructs the content using the retrieved components 210.

In an embodiment, only a single copy of each component 210 (e.g. image, photo, video, or audio) is stored by the content source 208. For example, any superimposed message on photos or videos is stored separately from the photos/videos (e.g. in a language specific library). As another example, audio tracks from videos may be stored separately from those videos as well.

Each component 210 may be stored as a file that has a fixed URL to be accessed, and it is this URL that is then be forwarded to the destination device 202 for each component of the requested content rather than the full file. The destination device 202 will then use the URLs it has received from the content manager 204 to retrieve the components 210 of the content source 208.

For example, based on a request from the destination device 202 for a movie comprised of an audio component and a video component, the audio file in a specific language (or default language per destination device 202 profile) and the video file may be retrieved by the destination device 202 using the provided URLs and the destination device 202 may then reconstruct the content using those components.

As an option, the video component may be divided into small fixed length segments and then the segments sent to the destination device 202. This allows processing, management, and monitoring the quality of the video. Each video segment may be compressed at the content source 208. This significantly reduces the size of the file to be transported across the network(s). The compressed file is transported through the network to the destination device 202. The video is then decompressed at the destination device 202. As an option, buffering may start in an extended flash memory and the content may then be streamed from there.

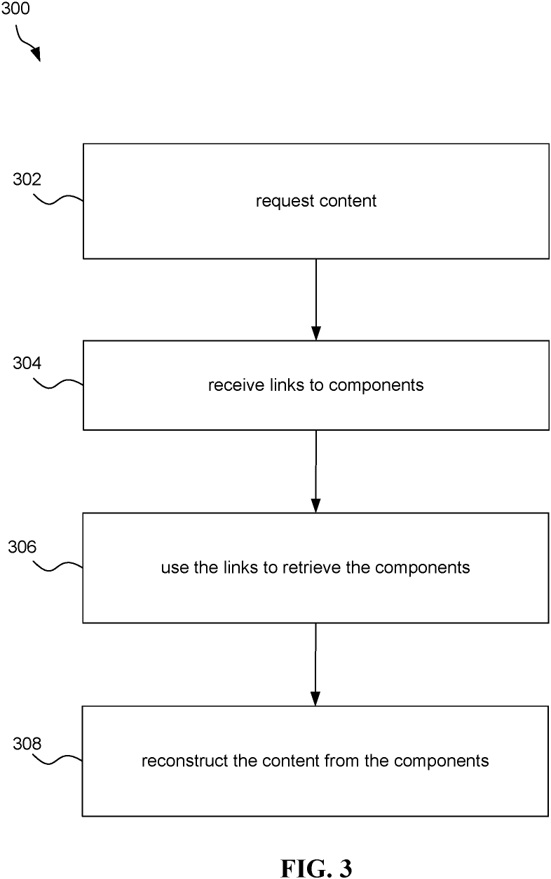

FIG. 3 illustrates a method 300 for reconstructing data, in accordance with one embodiment. As an option, the method 300 may be carried out in the context of the details of the previous figure and/or any subsequent figure(s). For example, the method 300 may be carried out by the destination device 202 of FIG. 2. Of course, however, the method 300 may be carried out in the context of any desired environment. Further, the aforementioned definitions may equally apply to the description below.

In operation 302, content is requested. In operation 304, links to components making up the content are received. In operation 306, the links are used to retrieve the components. In operation 308, the content is reconstructed from the components.

FIG. 4 illustrates a network architecture 400, in accordance with one possible embodiment. As shown, at least one network 402 is provided. In the context of the present network architecture 400, the network 402 may take any form including, but not limited to a telecommunications network, a local area network (LAN), a wireless network, a wide area network (WAN) such as the Internet, peer-to-peer network, cable network, etc. While only one network is shown, it should be understood that two or more similar or different networks 402 may be provided.

Coupled to the network 402 is a plurality of devices. For example, a server computer 404 and an end user computer 406 may be coupled to the network 402 for communication purposes. Such end user computer 406 may include a desktop computer, lap-top computer, and/or any other type of logic. Still yet, various other devices may be coupled to the network 402 including a personal digital assistant (PDA) device 408, a mobile phone device 410, a television 412, etc.

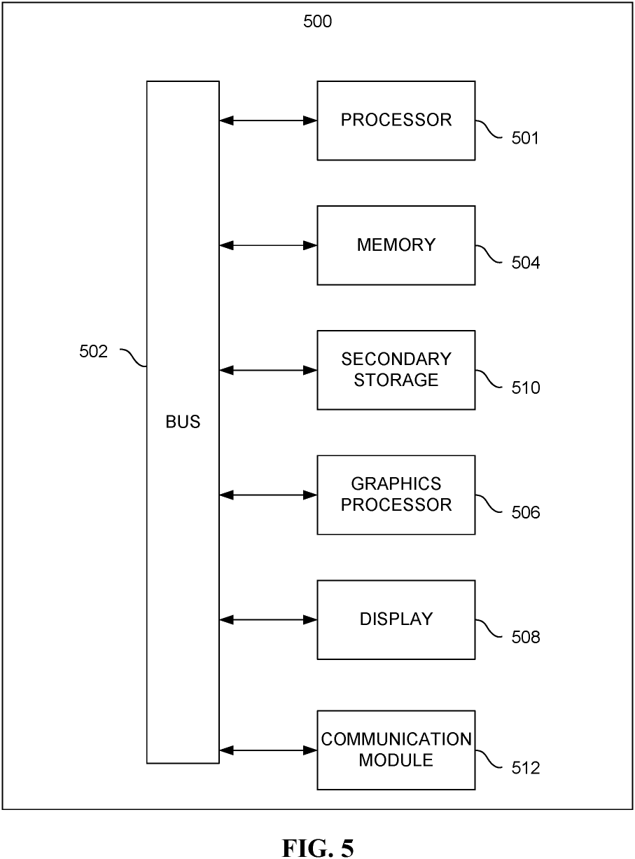

FIG. 5 illustrates an exemplary system 500, in accordance with one embodiment. As an option, the system 500 may be implemented in the context of any of the devices of the network architecture 400 of FIG. 4. Of course, the system 500 may be implemented in any desired environment.

As shown, a system 500 is provided including at least one central processor 501 which is connected to a communication bus 502. The system 500 also includes main memory 504 [e.g. random access memory (RAM), etc.]. The system 500 also includes a graphics processor 506 and a display 508.

The system 500 may also include a secondary storage 510. The secondary storage 510 includes, for example, solid state drive (SSD), flash memory, a removable storage drive, etc. The removable storage drive reads from and/or writes to a removable storage unit in a well-known manner.

Computer programs, or computer control logic algorithms, may be stored in the main memory 504, the secondary storage 510, and/or any other memory, for that matter. Such computer programs, when executed, enable the system 500 to perform various functions (as set forth above, for example). Memory 504, storage 510 and/or any other storage are possible examples of non-transitory computer-readable media.

The system 500 may also include one or more communication modules 512. The communication module 512 may be operable to facilitate communication between the system 500 and one or more networks, and/or with one or more devices through a variety of possible standard or proprietary communication protocols (e.g. via Bluetooth, Near Field Communication (NFC), Cellular communication, etc.).

As used here, a “computer-readable medium” includes one or more of any suitable media for storing the executable instructions of a computer program such that the instruction execution machine, system, apparatus, or device may read (or fetch) the instructions from the computer readable medium and execute the instructions for carrying out the described methods. Suitable storage formats include one or more of an electronic, magnetic, optical, and electromagnetic format. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high definition DVD (HD-DVD™), a BLU-RAY disc; and the like.

It should be understood that the arrangement of components illustrated in the Figures described are exemplary and that other arrangements are possible. It should also be understood that the various system components (and means) defined by the claims, described below, and illustrated in the various block diagrams represent logical components in some systems configured according to the subject matter disclosed herein.

For example, one or more of these system components (and means) may be realized, in whole or in part, by at least some of the components illustrated in the arrangements illustrated in the described Figures. In addition, while at least one of these components are implemented at least partially as an electronic hardware component, and therefore constitutes a machine, the other components may be implemented in software that when included in an execution environment constitutes a machine, hardware, or a combination of software and hardware.

More particularly, at least one component defined by the claims is implemented at least partially as an electronic hardware component, such as an instruction execution machine (e.g., a processor-based or processor-containing machine) and/or as specialized circuits or circuitry (e.g., discreet logic gates interconnected to perform a specialized function). Other components may be implemented in software, hardware, or a combination of software and hardware. Moreover, some or all of these other components may be combined, some may be omitted altogether, and additional components may be added while still achieving the functionality described herein. Thus, the subject matter described herein may be embodied in many different variations, and all such variations are contemplated to be within the scope of what is claimed.

In the description above, the subject matter is described with reference to acts and symbolic representations of operations that are performed by one or more devices, unless indicated otherwise. As such, it will be understood that such acts and operations, which are at times referred to as being computer-executed, include the manipulation by the processor of data in a structured form. This manipulation transforms the data or maintains it at locations in the memory system of the computer, which reconfigures or otherwise alters the operation of the device in a manner well understood by those skilled in the art. The data is maintained at physical locations of the memory as data structures that have particular properties defined by the format of the data. However, while the subject matter is being described in the foregoing context, it is not meant to be limiting as those of skill in the art will appreciate that several of the acts and operations described hereinafter may also be implemented in hardware.

To facilitate an understanding of the subject matter described herein, many aspects are described in terms of sequences of actions. At least one of these aspects defined by the claims is performed by an electronic hardware component. For example, it will be recognized that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

The embodiments described herein included the one or more modes known to the inventor for carrying out the claimed subject matter. Of course, variations of those embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A non-transitory computer-readable media storing computer instructions which when executed by one or more processors of a device cause the device to:
identify content to be transferred to a destination device over a network;
analyze metadata associated with the content to determine a plurality of components that are required to construct the content, wherein the metadata includes identifiers of the plurality of components, and wherein the plurality of components include at least a video component divided into a plurality of fixed length segments;
access a content manager device storing a plurality of previously generated links pointing to a plurality of files storing the plurality of components, wherein each link of the plurality of previously generated links corresponds to a different file of the plurality of files storing a different component of the plurality of components, and wherein the plurality of files are stored by a content source device separate from the content manager device;
retrieve, from the content manager device, the plurality of previously generated links pointing to the plurality of files storing the plurality of components; and
transfer the plurality of links to the destination device over the network for use by the destination device to retrieve the plurality of components from the content source device, including individually retrieving the fixed length segments comprising the video component, and to construct the content using the retrieved plurality of components.

2. The non-transitory computer-readable media of claim 1, wherein the content is identified in response to receipt of a request to transfer the content to the destination device.

3. The non-transitory computer-readable media of claim 2, wherein the request is received from the destination device.

4. The non-transitory computer-readable media of claim 1, wherein the destination device is a user device.

5. The non-transitory computer-readable media of claim 1, wherein the content is digital media content.

6. The non-transitory computer-readable media of claim 1, wherein the plurality of components include two or more of:
an image,
audio,
video, or
text.

7. The non-transitory computer-readable media of claim 6, wherein the content includes the text superimposed on the image or the video.

8. The non-transitory computer-readable media of claim 6, wherein the content includes the video and the audio.

9. (canceled)

10. The non-transitory computer-readable media of claim 1, wherein only a single copy of each component of the plurality of components is stored by the content source device.

11. The non-transitory computer-readable media of claim 10, wherein each component of the plurality of components is reusable to construct other content.

12. (canceled)

13. (canceled)

14. The non-transitory computer-readable media of claim 1, wherein the plurality of links are each a uniform resource locator (URL).

15. The non-transitory computer-readable media of claim 1, wherein the destination device retrieves the plurality of components using the plurality of links.

16. The non-transitory computer-readable media of claim 15, wherein the destination device constructs the content using the retrieved plurality of components.

17. The non-transitory computer-readable media of claim 15, wherein at least a portion of the plurality of components retrieved by the destination device are compressed.

18. (canceled)

19. A method, comprising:
at a computer system:
identifying content to be transferred to a destination device over a network;
analyzing metadata associated with the content to determine a plurality of components that are required to construct the content, wherein the metadata includes identifiers of the plurality of components, and wherein the plurality of components include at least a video component divided into a plurality of fixed length segments;
accessing a content manager device storing a plurality of previously generated links pointing to a plurality of files storing the plurality of components, wherein each link of the plurality of previously generated links corresponds to a different file of the plurality of files storing a different component of the plurality of components, and wherein the plurality of files are stored by a content source device separate from the content manager device;
retrieving, from the content manager device, the plurality of previously generated links pointing to the plurality of files storing the plurality of components; and
transferring the plurality of links to the destination device over the network for use by the destination device to retrieve the plurality of components from the content source device, including individually retrieving the fixed length segments comprising the video component, and to construct the content using the retrieved plurality of components.

20. A system, comprising:
a non-transitory memory storing instructions; and
one or more processors in communication with the non-transitory memory that execute the instructions to:
identify content to be transferred to a destination device over a network;
analyze metadata associated with the content to determine a plurality of components that are required to construct the content, wherein the metadata includes identifiers of the plurality of components, and wherein the plurality of components include at least a video component divided into a plurality of fixed length segments;
access a content manager device storing a plurality of previously generated links pointing to a plurality of files storing the plurality of components, wherein each link of the plurality of previously generated links corresponds to a different file of the plurality of files storing a different component of the plurality of components, and wherein the plurality of files are stored by a content source device separate from the content manager device;
retrieve, from the content manager device, the plurality of previously generated links pointing to the plurality of files storing the plurality of components; and
transfer the plurality of links to the destination device over the network for use by the destination device to retrieve the plurality of components from the content source device, including individually retrieving the fixed length segments comprising the video component, and to construct the content using the retrieved plurality of components.

21. The non-transitory computer-readable media of claim 1, the plurality of components include at least:
a first component that is the video component comprised of video, and
a second component comprised of a message to be superimposed on the video,
wherein the second component is stored in a language specific library.

22. The non-transitory computer-readable media of claim 1, the plurality of components include at least:
a first component that is the video component comprised of video, and
a second component comprised of an audio track corresponding to the video,
wherein the audio track includes audio in a language per a profile of the destination device.
